(19) United States
(12) Patent Application Publication
(10) Pub. No.: US 2018/0368368 A1
(43) Pub. Date: Dec. 27, 2018

(54) HOLDER FOR A COMESTIBLE PET TREAT

(71) Applicant: BIG HEART PET, INC., Orrville, OH (US)

(72) Inventor: Darin Y. Matsubara, Akron, OH (US)

(73) Assignee: BIG HEART PET, INC., Orrville, OH (US)

(21) Appl. No.: 15/634,808

(22) Filed: Jun. 27, 2017

(51) Int. Cl. A01K 15/02; A01K 5/00

(52) U.S. Cl. CPC A01K 15/026; A01K 5/00

(57) ABSTRACT

A pet treat holder and comestible pet treat are disclosed, the pet treat holder including a first member having an opening configured to receive a comestible pet treat, and a cavity in communication with the opening on a lower surface of the first member and configured to receive the comestible pet treat, and wherein the opening is sized such that only a portion the comestible pet treat is accessible from an upper surface of the first member. The comestible pet treat includes an upper portion sized to fit within the opening of the pet treat holder, and a base portion attached to the upper portion, the base portion having a flange, which extends around an outer edge of the base portion and is configured to engage a lower surface of the pet treat holder adjacent to the opening.

### FIELD OF THE INVENTION

The present disclosure relates to a holder for a comestible pet treat, and more particularly, a holder for a comestible pet treat, which can be configured, for example, as a bowl or mat, and such that only a portion of the comestible pet treat is accessible to the pet.

### BACKGROUND OF THE INVENTION

Comestible pet treats for companion animals are often offered as rewards for good behavior, training enticements, and special occasions. The treat of this disclosure extends the interaction time between the owner and the companion animal, such as a cat or dog, by preventing the pet from easily consuming the comestible pet treat and helps reduce mess associated during the consumption of the comestible pet treat.

### SUMMARY OF THE INVENTION

Accordingly, it would be desirable to have a holder, for example, in the shape of a bowl or mat, which is designed to hold a specific shaped and sized comestible or edible treat that allows the animal to lick the edible treat and helps prevents the animal from chewing or eating the treat whole. In addition, by preventing the animal from devouring the treat in its entirety since only a portion of the treat is accessible, the animal must resort to licking the product.

A pet treat holder is disclosed, comprising: a first member having an opening configured to receive a comestible pet treat; and a cavity in communication with the opening on a lower surface of the first member and configured to receive the comestible pet treat, and wherein the opening is sized such that only a portion of the comestible pet treat is accessible from an upper surface of the first member.

A comestible pet treat configured to be received within an opening of a pet treat holder in which only a portion the comestible pet treat is accessible from an upper surface of the pet treat holder is disclosed, the comestible pet treat comprising: an upper portion sized to fit within the opening of the pet treat holder; and a base portion attached to the upper portion, the base portion having a flange, which extends around an outer edge of the base portion and configured to engage a lower surface of the pet treat holder adjacent to the opening.

It is to be understood that both the foregoing general description and the following detailed description are exemplary and explanatory and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a perspective and exploded view of holder for a comestible pet treat, and wherein the comestible pet treat can be loaded from a lower surface of the holder in accordance with an exemplary embodiment.

FIG. 2 is a perspective view and a cross-sectional view of a holder for a comestible pet treat having a screw top in accordance with an exemplary embodiment.

FIG. 3 is a cross-sectional view of the holder for a comestible pet treat of FIG. 2 in accordance with an exemplary embodiment.

FIG. 4 is a perspective view and a side view of a holder for a comestible pet treat in accordance with another exemplary embodiment.

FIG. 5 is a perspective view and a side view of a holder for a comestible pet treat having a screw tip or press fit in accordance with an exemplary embodiment.

FIG. 6 are perspective views of a holder for a comestible pet treat, and wherein the comestible pet treat can be loaded from a lower surface of the holder in accordance with an exemplary embodiment.

FIG. 7 is a perspective view and a side view of a holder for a comestible pet treat, and wherein the comestible pet treat can be loaded from a lower surface of the holder in accordance with another exemplary embodiment.

FIG. 8 is a perspective view and a side view of a holder for a comestible pet treat, and wherein the comestible pet treat can be loaded from a lower surface of the holder in accordance with another exemplary embodiment.

FIG. 9 is a perspective view and a side view of a holder for a comestible pet treat, and wherein the comestible pet treat can be side loaded into the holder in accordance with another exemplary embodiment.

FIG. 10 is a perspective view, a side view, and an end view of a holder for a comestible pet treat, and wherein the comestible pet treat can be loaded from an upper surface of the holder in accordance with another exemplary embodiment.

FIG. 11 is a perspective view, a side view, and an end view of a holder for a comestible pet treat, and wherein the comestible pet treat can be loaded from an upper surface of the holder in accordance with another exemplary embodiment.

### DETAILED DESCRIPTION

Reference is now made in detail to the present preferred embodiments of the invention, examples of which are illustrated in the accompanying drawings. Wherever possible, the same reference numbers are used in the drawings and the description to refer to the same or like parts.

Pets will often chew or eat an entirety of a comestible pet treat in a short time. Thus, it would be desirable to extend the consumption time of a comestible pet treat and which occupies the pet in a safer manner as compared to other occupational treats by placing the comestible pet treat in a holder, which forces the animal to lick the treat rather than chewing or eating the entirety of the treat.

In addition, conventional occupation treats, for example, long lasting chews can get lodged in the digestive tract, break or damage teeth, and create a mess. Accordingly, it would be desirable to have a method and system of providing a comestible pet treat, which does not lodge in the digestive tract since the comestible pet treat is not fully consumed all at once, but rather consumed one lick at a time. In addition, the comestible pet treat will not break or damage the pet's teeth, since only a portion of the treat is accessible.

In addition, excess calories can be managed as the treat can be sized appropriately as the occupation time for consuming the treat can be a function of how the treat is consumed and not a function of the mass or rigidity of the treat itself. The invention can also minimize a potential for a mess as the edible part of the treat is confined to a bowl or mat that can be configured to hold or capture any excess portions of the treat and/or saliva of the pet.

In accordance with an exemplary embodiment, a holder for a comestible pet treat is disclosed, which allows the pet to only lick the product and not consume the entire comestible pet treat. Another design feature of the bowl is to design the holder in a shape of a bowl such that the center of gravity is configured such that the bowl cannot be flipped. The mat is designed such that the pet's paws are placed or positioned on the mat such that the mat cannot be flipped as the pet licks the treat. The holder can also be designed that any excess saliva can be caught and prevented from seeping to the floor and containing any mess to help with clean up.

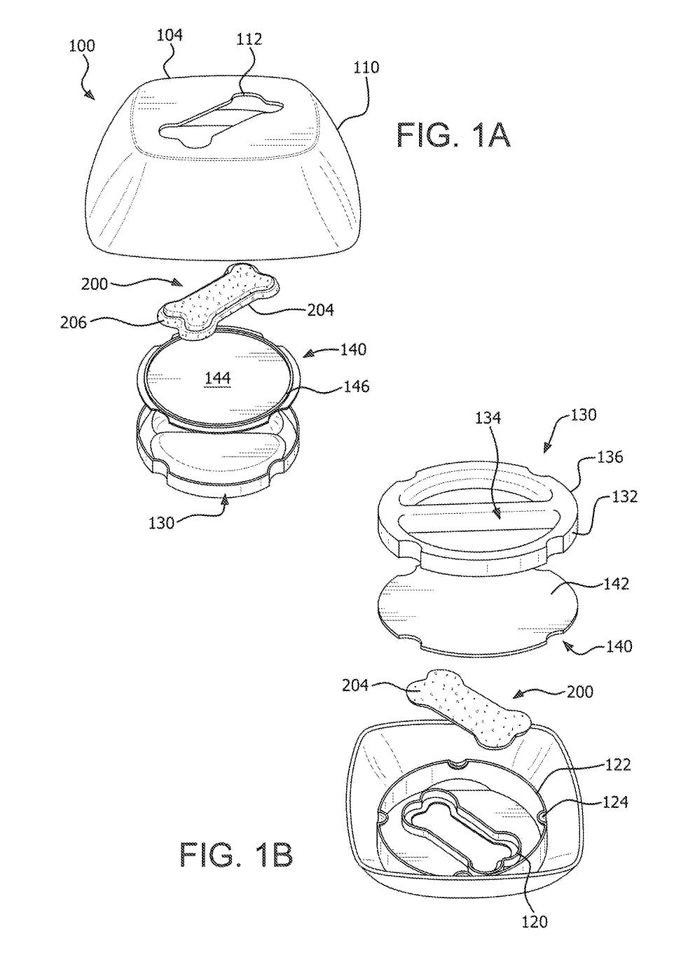

FIG. 1 is a perspective and expanded view of a holder 100 for a comestible pet treat 200 having a snap fit or screw top in accordance with an exemplary embodiment. As shown in FIG. 1, the holder 100 includes a first member 110 having an opening 112 configured to receive the comestible pet treat 200. The first member 110 includes a cavity 120 in communication with the opening 112 on a lower surface 102 of the first member 110 and configured to receive the comestible pet treat 200. In accordance with an exemplary embodiment, the opening 112 is sized such that only an upper portion 210 of the comestible pet treat 200 is accessible from an upper surface 104 of the first member 110.

As shown in FIG. 1, the cavity 120 can be configured to receive a cover 130 and an optional catch plate 140, which holds the comestible pet treat 200 within the cavity 120. For example, as shown in FIG. 1, the cover 130 can be a circular plate 132 having a pair of recessed grooves or cavities 134 configured to receive two or more fingers of a user to help assist the user to place the cover 130 within the cavity 120. On an inner surface 122 of the cavity 120, one or more flanges (or tabs) 124 can be arranged to receive an outer edge 136 of the cover 130, which imparts a predetermined amount of pressure on the comestible pet treat 200 and which locks the comestible pet treat 200 into the opening 112. Alternatively, the one or more flanges (or tabs) 124 on the outer edge of the cover 130 can include a groove or slot configured to receive a corresponding flange or tab (not shown) on the outer edge 136 of the cover 130.

The optional catch plate 140 includes a lower surface 142 and an upper surface 144. In accordance with an exemplary embodiment, an outer diameter 138 of the catch plate 140 can be approximately equal to an outer diameter 138 of the outer edge 136 of the cover 120. The catch plate 140 can include an annular lip or flange 146 on the upper surface 144 of the catch plate 140, which forms a bowl or container to prevent saliva from gathering on the cover 120 and/or dripping beneath the cavity 120.

In accordance with an exemplary embodiment, the holder 100 and/or the first member 110 can be sized such that an angle of an outer surface 116 of the first member 110 and/or center of gravity of the first member 100 is designed such that a pet cannot flip the first member 110 over during consumption of the comestible pet treat 200. For example, in accordance with an exemplary embodiment, the angle of outer surface 116 can be between about 30 degrees to 60 degrees.

In accordance with an exemplary embodiment, the holder 100 can be made from, for example, plastics, composites, metals, natural materials, wood, rubber, ceramic, and/or synthetic materials, or any combination thereof.

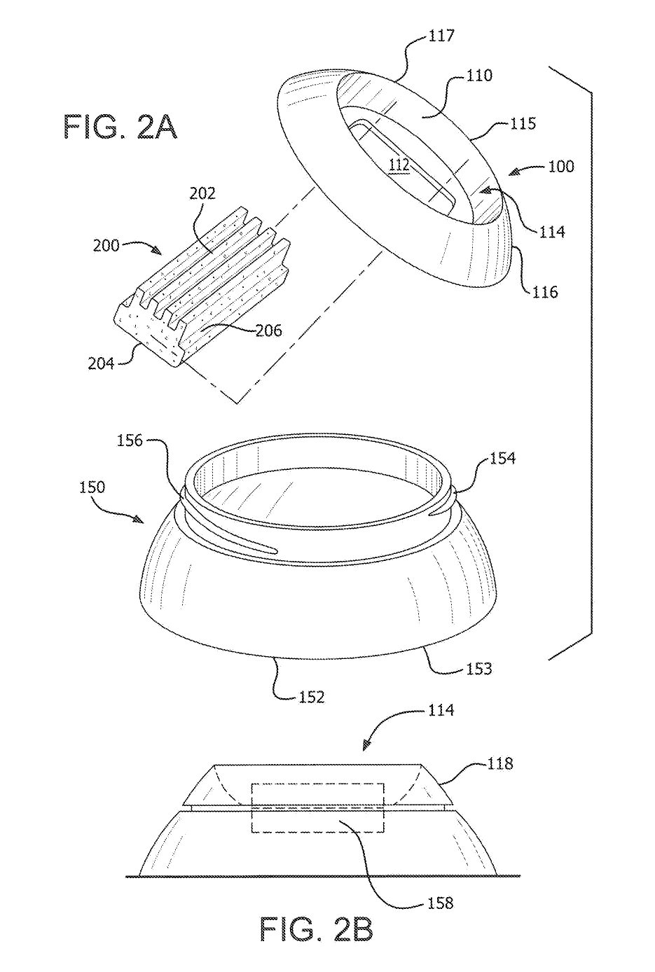

FIG. 2 is a perspective view and cross-sectional view of a holder 100 for a comestible pet treat 200 having a screw top in accordance with an exemplary embodiment. As shown in FIG. 2, the first member 110 can be in the shape of, for example, a bowl, having a concave or recessed portion 114, which surrounds the opening 112. The concave or recess portion 114 can be configured to capture moisture and excess saliva from the pet during consumption of the comestible pet treat 200 and/or portions of the comestible pet treat 200 that may break off during consumption.

In accordance with an exemplary embodiment, the holder 100 includes a second member 150 having a series of external threads 154 on an upper edge 156 of the second member 150. The second member 150 includes a lower surface 152, which can include, for example, an annular base 153. The second member 150 can also include a platform or plate 158 upon which a lower surface 204 of the comestible pet treat 200 rests upon an assembly connecting the first member 110 to the second member 150.

As shown in FIG. 2, the first member 110 can have an outer flange 116, which extends from an upper edge 115 of an annular edge 117 of the concave portion 114 and an inner surface 118 of the outer flange 116 having a series of internal threads 118, which are configured to engage the series of external threads 154 on the second member 150.

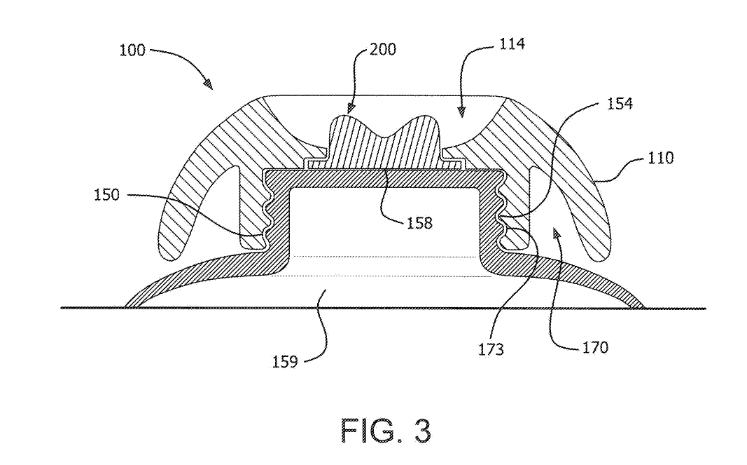

FIG. 3 is a cross-sectional view of the holder 100 for a comestible pet treat 200 in accordance with an exemplary embodiment. As shown in FIG. 3, the holder 100 can include a first member 110 that can be in the shape of, for example, a bowl, having a concave or recessed portion 114, which surrounds the opening 112. The concave or recess portion 114 can be configured to capture excess saliva from the pet during consumption of the comestible pet treat 200 and/or portions of the comestible pet treat 200 that may break off during consumption.

In accordance with an exemplary embodiment, the first member 110 can be sized such that an angle of an outer surface 116 of the first member 110 and/or center of gravity of the first member 100 is designed such that a pet cannot flip the first member 110 over during consumption of the comestible pet treat 200. For example, in accordance with an exemplary embodiment, the angle of outer surface 116 can be between about 30 degrees to 60 degrees.

In accordance with an exemplary embodiment, the holder 100 as shown in FIG. 3 includes a second member 150 having a series of external threads 154 on an upper edge 156 of the second member 150. The second member 150 also includes a platform or plate 158 upon which a lower surface 204 of the comestible pet treat 200 rests upon an assembly connecting the first member 110 to the second member 150.

As shown in FIG. 3, the first member 110 can have an outer flange 116, which extends from an upper edge 115 of an annular edge 117 of the concave portion 114 and an inner surface 118 of the outer flange 116 having a series of internal threads 118, which are configured to engage the series of external threads 154 on the second member 150. As shown in FIG. 3, the outer flange 118 can include an annular groove 170 on a lower surface 172 of the outer flange 118. The second member 150 can include an optional cavity 159 located underneath the platform or plate 158.

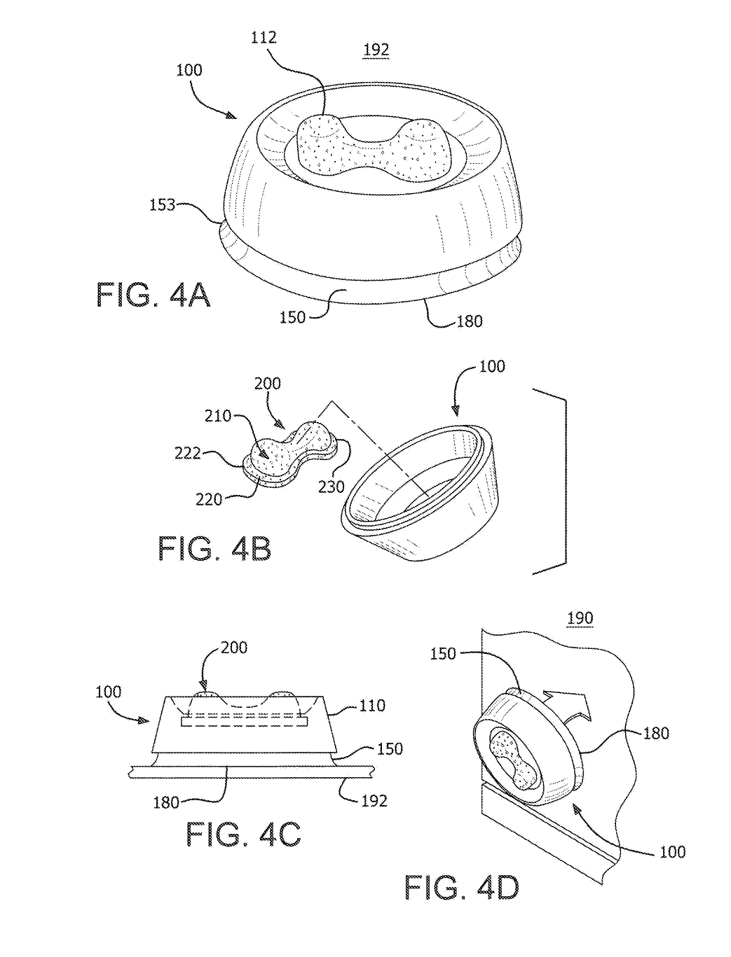

FIG. 4 is a perspective view and a side view of a holder 100 for a comestible pet treat 200 in accordance with another exemplary embodiment. As shown in FIG. 4, the holder 100 can include a first member 110 and a second member 150 as shown, for example, in FIGS. 2 and 3. In addition, the second member 150 includes at least one suction cup 180 attached to the annular base 153. The suction cup 180 can be an annular plate, which covers an entirety of the annular base 153, or two or more suction cups 180 can be equally spaced around the annular base 153. Alternatively, rather than two or more suction cups 180, rubber stops or gaskets can be used to help prevent the holder from sliding along a floor or surface. In accordance with an exemplary embodiment, the holder 100 can be attached or fixed, for example, to a wall 190 or a floor 192.

Alternatively, rather than at least one suction cup 180, for example, the second member 150 can include an adhesive on the annular base of the second member 150, a Velcro or Velcro-like material. For example, in accordance with an exemplary embodiment, the lower surfaces 112, 152 of the first and/or second member 110, 150 can include one or more Velcro strips or patches, which can be used, for example, to secure the holder 100 on a carpet or carpet like material.

As shown in FIG. 4, the comestible pet treat 200 preferably has a hard texture that can be consumed by licking rather than chewing. With this feature, the companion animal or pets needs a longer time to eat the treat 200 completely because licking takes longer than chewing to completely consume the comestible pet treat 200. Simultaneously, for example, if the companion animal tires of the treat 200 and any related attention from the owner, the owner can dispose of the unused portion of the treat 200 or save it for reuse on another occasion. In addition, the consumption time frame and pet attention time frame will vary from pet species to pet species and the comestible pet treat 200 can be sized to accommodate the pet's interest by providing different size treats 200 with different compositions in an upper portion 210 and a lower portion (or base portion) 220.

Another intended feature for a comestible pet treat 200 according to this disclosure is to elicit an intense reaction from the pet. To this end, the comestible pet treat 200 ought to be highly palatable and desirable for the pet. For example, where the intended pet is a cat, the treat 200 may have the flavor of fish, poultry, or other flavors as to which cats have been found to be attracted. For example, the structural embodiment of the treat 200 can be selected from a variety of shapes and configurations.

To promote the organoleptic response of the pet, the edible portion of a suitable comestible treat 200 may have a composition with a dextrose, sucrose, or fructose base (for example, a sugar base), and may include a flavor compound such as dried meat, dried fish, dry digest, or other compound tailored to the target companion animal Materials such as dried meat, dried fish, and dried digest are particularly favored, for example, by cats and are thus highly palatable. In addition to the dextrose, sucrose, or fructose base, the treat 200 can include starch so that its formulation gives a hard-candy texture and composition. Other suitable ingredients can include corn syrup, starch gums, coloring agents, and/or preservatives, if necessary.

In accordance with an exemplary embodiment, dry palatants may be incorporated into the treats 200 to drive indulgence and elicit a strong organoleptic response from the companion animal. The dry palatants can be meat, poultry, fish, or dry digest. During preparation of the treats 200, the palatant ingredients may be pre-cooked for quicker production, or be processed with the dextrose, sucrose, or fructose base in such a way that the palatant ingredients are cooked during preparation of the treats.

The component formulation for the comestible pet treat 200 according to this disclosure may include, for example, dextrose, corn syrup, dried digest, artificial color, liver flavor, salt, onion extract and/or garlic powder, in any combination. In accordance with an exemplary embodiment, dextrose (for example, sugar) can be the base or principal ingredient for the edible portion of the treat. The next most prevalent ingredient can be the dry digest, which may comprise a starch to create a hard, candy-like texture for the edible portion of the treat. It is also contemplated that the edible portion may have a jelly-like or taffy-like texture either of which may be softer than a hard, candy-like texture.

As shown in FIG. 4, the comestible pet treat 200 can include an upper portion 210 sized to fit within the opening 112 of the first member 110 of the holder 100, and a base portion (or lower portion) 220 attached to the upper portion 210. In accordance with an exemplary embodiment, the base portion 220 has a flange 230, which extends around an outer edge 222 of the base portion 220 and configured to engage a lower surface 102 of the first member 110 of the holder 100 adjacent to the opening 112.

In accordance with an exemplary embodiment, for example, the upper portion 210 of the comestible pet treat 200 can be comprised of a different composition of a sugar, a dry digest, and/or a flavorant than the base portion 220 of the comestible pet treat 200. In addition, the comestible pet treat 200 can include a liquid center (not shown) within the base portion 220 of the comestible pet treat 200. For example, in accordance with an exemplary embodiment, the upper portion 210 has a first flavorant and the base portion 220 has a second flavorant, the first and second flavorants being different. In accordance with another exemplary embodiment, the upper portion 210 can be a first color and the base portion 220 can be a second color.

In accordance with an exemplary embodiment, at least one of the upper portion 210 and/or the base portion 220 swells upon exposure to moisture and/or saliva to lock the upper portion 210 and/or the base portion 220 within the opening 112 of the holder 100.

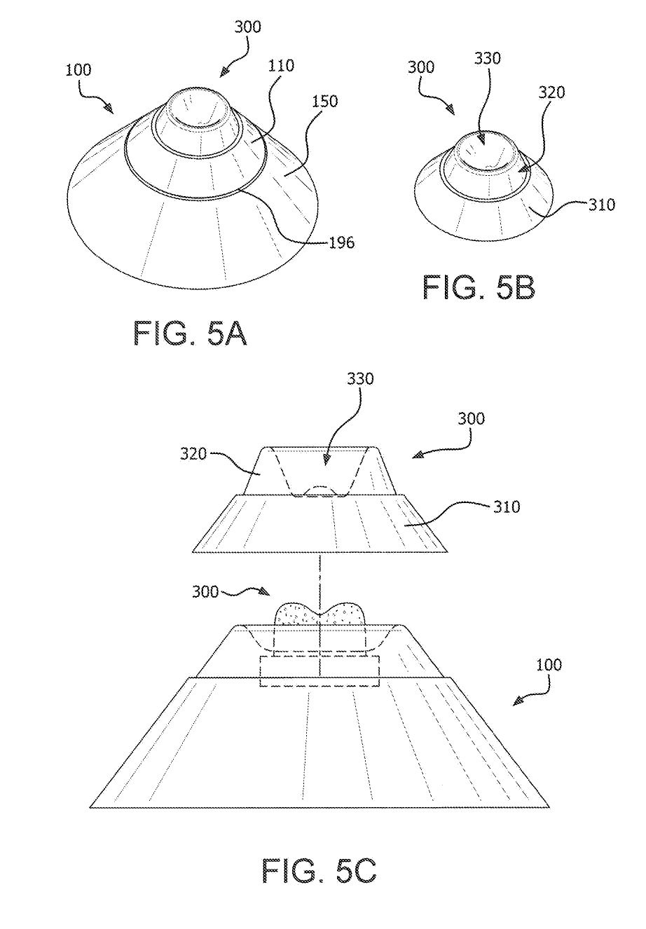

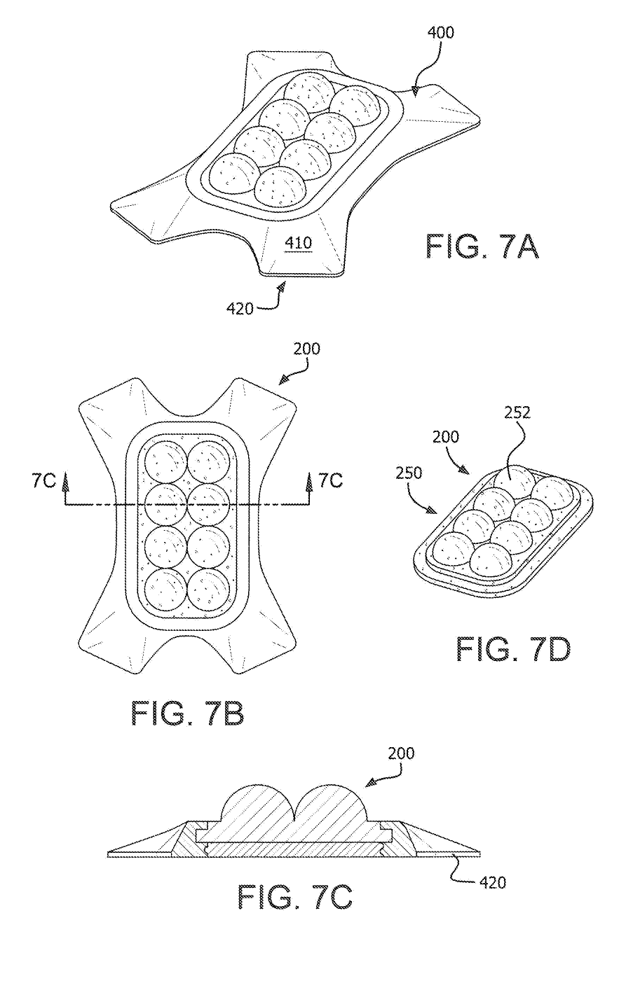

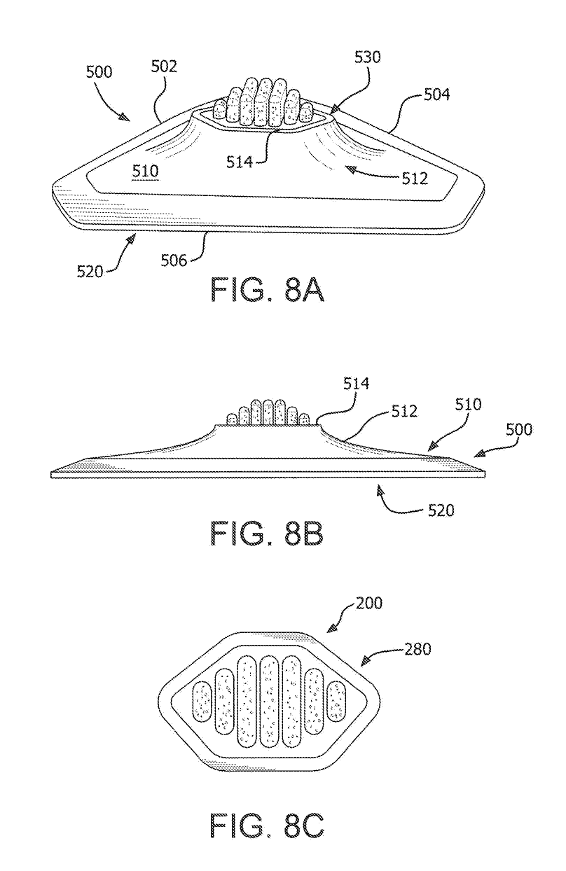

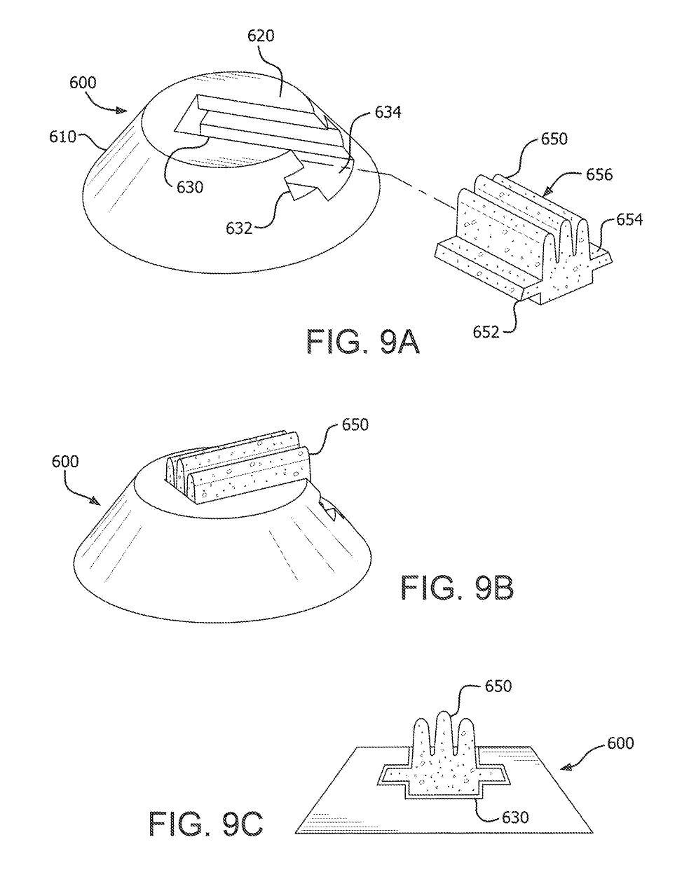

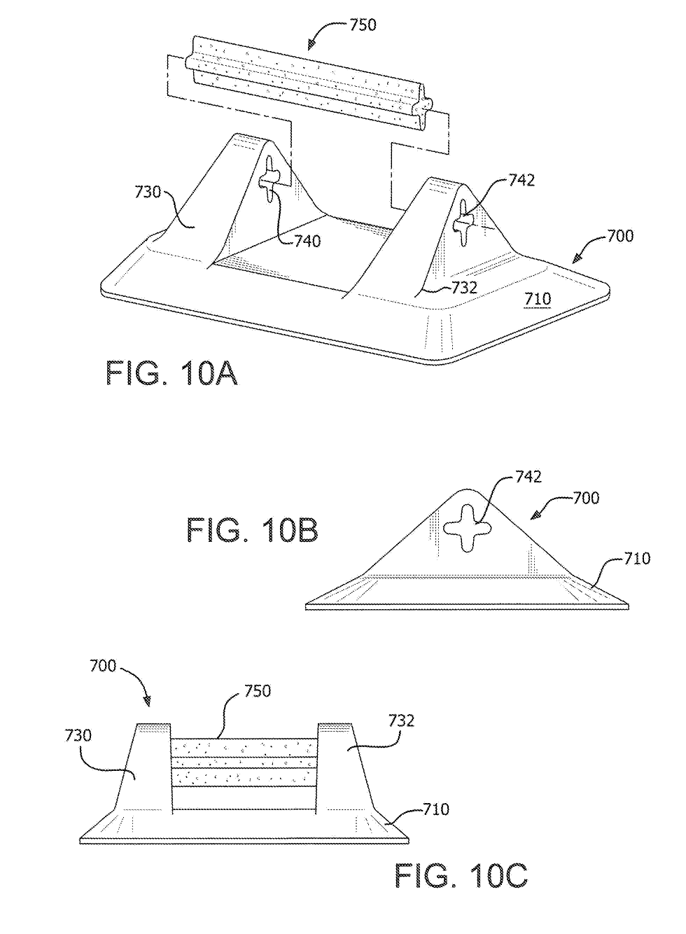

As shown in FIG. 4, the comestible pet treat 200 can include an upper portion 210 in a shape of a dog bone, or any other desired shape including an extruded or formed bar with ridges (FIG. 2), a circular or round shape (FIG. 5), a plurality of round ovals (FIG. 7), a triangular shape with grooves (FIG. 8), a rectangular grooved lick (FIG. 9), or star-shaped (FIG. 10). Alternatively, the comestible pet treat 200 can have any desired shape including, by way of example, a dog bone, a T-bone shape, a chicken bone, a chicken leg, a turkey leg, a circle, a sphere, a fish, a heart, a paw, an embossed design, or a rectangular prism with tapered sides.

FIG. 5 is a perspective view and a side view of a holder 100 for a comestible pet treat having a locking mechanism in the form of a screw top or press fit in accordance with an exemplary embodiment. As shown in FIG. 5, the first member 110 of the holder 100 has a cylindrical opening 112 configured to receive a cone-shaped comestible pet treat 300. The cone-shaped comestible pet treat 300 preferably has a cylindrical base 310 in the form of a cylindrical plate, and an upper portion forming a cone 320 having a cavity 330 therein.

In accordance with an exemplary embodiment, the first member 110 and the second member 150 are cone-shaped and can include a locking mechanism 196, such as a screw top as shown in FIG. 2, or alternatively, can be a press-fit wherein the first member 110 is sized to fit over an upper portion of the second member 150 with a screw top, for example, a pair of threads on the outer surface of second member 150, which engage a series of threads on the inner surface of the first member as shown, for example, in FIG. 2. In accordance with an exemplary embodiment, the locking mechanism 196 can include, for example, at least one tab or flange (not shown) on the outer surface of the second member 150 and a corresponding flange or tab 124 on the inner surface 122 of the first member 110 to form a press fit as shown in FIG. 1.

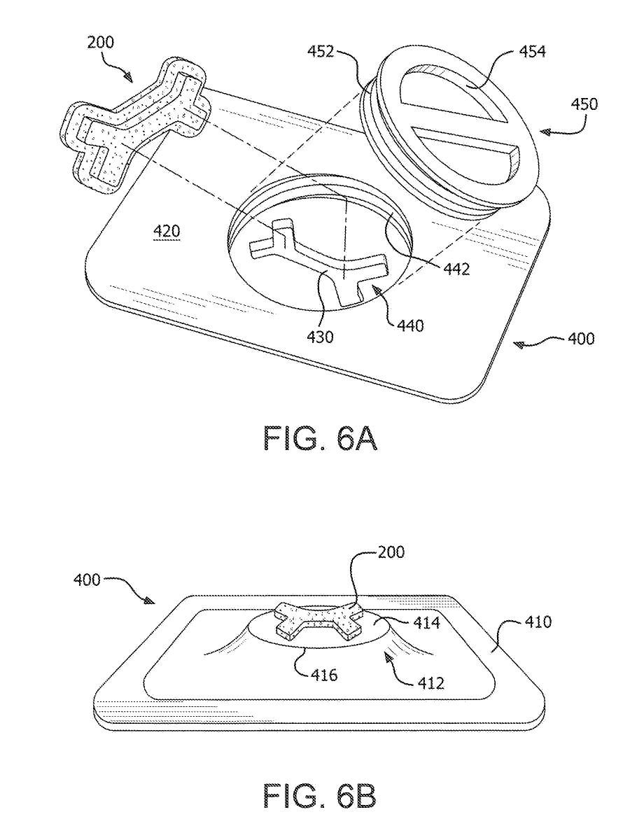

FIG. 6 shows perspective views of a holder 400 for a comestible pet treat 200, and wherein the comestible pet treat 200 can be loaded from a lower 420 surface of the holder 400 in accordance with an exemplary embodiment. As shown in FIG. 6, the holder 400 can be in the form of a mat having any desired shape. The holder 400 includes an upper surface 410, a lower surface 420, an opening 430 on the surface 410, which is configured to receive the comestible pet treat 200, and a cavity 440, which is accessible from the lower surface 420 of the holder 400. In accordance with an exemplary embodiment, the upper surface 410 of the holder 400 includes a convex portion or raised portion 412, which surrounds the opening 430, which is configured to receive the comestible pet treat 200. The convex portion or raised portion 412 can include a relatively flat or horizontal surface 414 having, for example, an oval or round outer diameter 416 which surrounds the opening 430.

In accordance with an exemplary embodiment, the holder 400 can be made of a flexible rubber material, for example, EPDM rubber (ethylene propylene diene monomer (M-class) rubber), polyurethane, a butyl rubber, a nitrile rubber, a styrene-butadiene (SBR) rubber, and/or a natural rubber, or any combination thereof.

As disclosed herein, the cavity 440 is in communication with the opening 430 on a lower surface 420 of the first member holder 400 and configured to receive the comestible pet treat 200. In accordance with an exemplary embodiment, the opening 430 is sized such that only a portion of the comestible pet treat 200 is accessible from the upper surface 410 of the holder 400.

As shown in FIG. 6, the cavity 440 can be configured to receive a cover 450 and an optional catch plate 140 (as shown in FIG. 1), which holds the comestible pet treat 200 within the cavity 440. For example, as shown in FIG. 6, the cover 450 can include a circular plate 452 having a pair of recessed grooves or cavities 454 configured to receive two or more fingers of a user when placing the cover 450 within the cavity 440. On an inner surface 442 of the cavity 440, a series of threads (or grooves) 444 can be arranged to receive a corresponding set of threads (or grooves) 456 on outer edge 458 of the cover 450, which imparts a predetermined amount of pressure on the comestible pet treat 200 and which locks the comestible pet treat 200 into the opening 430.

In accordance with an alternative embodiment, the cavity 440 and the cover 450 can be include a locking mechanism as shown in FIG. 1, which can include, for example, two or more sets of two or more flanges (tabs) 124 arranged to receive an outer edge 458 of the cover 450, and which imparts a predetermined amount of pressure on the comestible pet treat 200 and which locks the comestible pet treat 200 into the opening 430. Alternatively, the one or more flanges (or tabs) 124 can include a groove or slot configured to receive a corresponding flange or tab on the outer edge 458 of the cover 450.

In accordance with an exemplary embodiment, the holder 400 can include an optional catch plate 140 as shown in FIG. 1. In accordance with an exemplary embodiment, an outer diameter 138 of the catch plate 140 can be approximately equal to an outer diameter 459 of the outer edge 458 of the cover 450. The catch plate 140 can include an annular lip or flange 136 on the upper surface 144 forming a catch or bowl to prevent saliva from gathering on the cover 450 and/or dripping beneath the cavity 440.

In accordance with an exemplary embodiment, the holder 400 is at least 6 inches by 6 inches, for example, at least 9 inches by 9 inches, or 12 inches by 12 inches, such that when the pet is consuming the comestible pet treat 200, at least the front paws of the animal are resting on the holder 400. The holder 400 can be rectangular, square, round, elliptical, or any other desired shape, for example, the shape of a dog bone.

FIG. 7 is a perspective view and a side view of holder 400 for a comestible pet treat 200, and wherein the comestible pet treat 200 can be loaded from the lower surface 420 of the holder 400 in accordance with another exemplary embodiment. As shown in FIG. 7, the comestible pet treat 200 can be shaped as a plurality of small lumps, protuberances, or nubs 250 having, for example, an oval shape 252. The small lumps, protuberances, or nubs 250 can be arranged, for example, in one or more rows, for example, two rows of two or more.

FIG. 8 is a perspective view and a side view of a holder 500 for a comestible pet treat 200, and wherein the comestible pet treat can be loaded from a lower surface 520 of the holder 500 in accordance with another exemplary embodiment. As shown in FIG. 8, the holder 500 can be in the shape of a triangle having at least three (3) sides 502, 504, 506, an upper surface 510, and a lower surface 520. The three (3) sides can be connected to one another with a round edge, a straight edge as shown in FIG. 8, or any other suitable connection point.

In accordance with an exemplary embodiment, the holder 500 includes an upper surface 510, a lower surface 520, an opening 530 on the surface 510, which is configured to receive the comestible pet treat 200, and a cavity (not shown), which is accessible from the lower surface 520 of the holder 500. In accordance with an exemplary embodiment, the upper surface 510 of the holder 500 includes a convex portion or raised portion 512, which surrounds the opening 530, which is configured to receive the comestible pet treat 200. The convex portion or raised portion 512 can include a relatively flat or horizontal surface 514 having, for example, an outer diameter corresponding to the outer diameter of the comestible pet treat 200, and which surrounds the opening 430.

As disclosed herein, the cavity 540 is in communication with the opening 530 on a lower surface 520 of the first member holder 500 and configured to receive the comestible pet treat 200. In accordance with an exemplary embodiment, the opening 530 is sized such that only a portion of the comestible pet treat 200 is accessible from the upper surface 510 of the holder 500. In accordance with an exemplary embodiment, the comestible pet treat 200 can have four or more edges or sides, preferably, six (6) edges or sides 280 as shown in FIG. 8, with a series of raised protrusions running parallel to one another.

FIG. 9 is a perspective view and a side view of a holder 600 for a comestible pet treat 650, wherein the comestible pet treat 650 can be side loaded into the holder 600 in accordance with another exemplary embodiment. As shown in FIG. 9, the holder 600 includes a first member 610 having a generally cone shape with a relatively flat or horizontal upper surface 620 and a slot 630 configured to receive a comestible pet treat 650. The comestible pet treat 650 is preferably sized so at least a portion of the comestible pet treat extends above the upper surface 620. For example, in accordance with an exemplary embodiment, the comestible pet treat 650 can have a pair of flanges 652, 654, which are configured to be received in grooves 632, 634, of the slot 630. One or more ridges 656 of the comestible pet treat 650 extend upon the upper surface of the first member 610.

FIG. 10 is a perspective view, a side view, and an end view of a holder 700 for a comestible pet treat 750, and wherein the comestible pet treat 750 can be loaded from an upper surface 710 of the holder 700 in accordance with another exemplary embodiment. As shown in FIG. 10, the holder 700 includes an upper surface 710, a lower surface 720, and a pair of comestible pet treat holding members 730, 732. Each of the pair of comestible pet treat holding members 730, 732 having a groove or opening 740, 742 sized and/or shaped to receive ends of a corresponding sized and/or shaped comestible pet treat 750, which extends between the pair of comestible pet treat holding members 730,732. In accordance with an exemplary embodiment, the holder 700 is a flexible rubber mat.

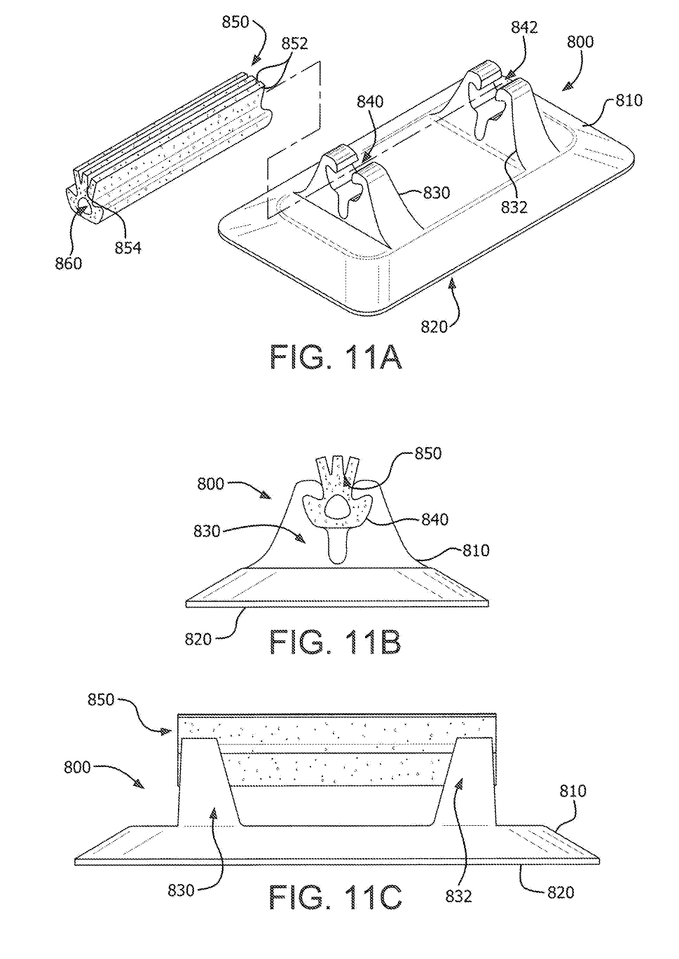

FIG. 11 is a perspective view, an end view, and a side view of a holder 800 for a comestible pet treat 850, and wherein the comestible pet treat 850 can be loaded from an upper surface 810 of the holder 800 in accordance with another exemplary embodiment. As shown in FIG. 11, the holder 800 includes an upper surface 810, a lower surface 820, and a pair of comestible pet treat holding members 830, 832. Each of the pair of comestible pet treat holding members 830, 832 having a groove or opening 840, 842 sized and/or shaped to receive ends of a corresponding sized and/or shaped comestible pet treat 850, which extends between the pair of comestible pet treat holding members 830, 832. In accordance with an exemplary embodiment, the holder 800 is a flexible rubber mat.

In accordance with an exemplary embodiment, the comestible pet treat 850 can include one or more grooves 852 on an upper surface of the comestible treat 850, which can be filled with a palatant material 854. In addition, the comestible treats 200, 650, 750, 850 can include a liquid or solid center 860, which is a different composition or flavor than the base portion and/or upper portion of the comestible pet treat 200, 650, 750, 850.

It will be apparent to those skilled in the art that various modifications and variation can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A pet treat holder comprising:
a first member having an opening configured to receive a comestible pet treat; and
a cavity in communication with the opening on a lower surface of the first member and configured to receive the comestible pet treat, and wherein the opening is sized such that only a portion the comestible pet treat is accessible from an upper surface of the first member.

2. The holder of claim 1, wherein first member has a concave portion, which surrounds the opening.

3. The holder of claim 2, wherein the first member is a bowl, the bowl having an outer edge having a frustoconical shape, and wherein an angle of the frustoconical shape of the outer wall to the lower surface of the first member is between about 30 degrees to about 60 degrees.

4. The holder of claim 3, comprising:
a second member having a series of external threads; and
the first member having an outer flange, which extends from an upper edge of an annular edge of the concave portion and an inner surface of the outer flange having a series of internal threads, which are configured to engage the series of external threads on the second member.

5. The holder of claim 4, comprising:
an adhesive, one or more suction cups, and/or a Velcro strip on a bottom surface of at least one of the first and/or second members configured to attach or fix the first and/or second members to a floor and/or wall.

6. The holder of claim 1, wherein the first member is a mat.

7. The holder of claim 1, comprising:
a cover, which is configured to be received within the cavity from an underside of the first member and holds the comestible pet treat within the cavity.

8. The holder of claim 7, wherein the cover has a recess on an upper portion of the cover and/or a raised lip on an outer edge of the upper portion of the cover to catch moisture and saliva from a pet licking and/or consuming the comestible pet treat.

9. The holder of claim 1, wherein the cavity includes a locking mechanism, and wherein the locking mechanism is configured to receive a cover having a corresponding locking mechanism.

10. The holder of claim 9, wherein the locking mechanism comprises an internal thread on an inner surface of the cavity and the cover having a corresponding external thread.

11. The holder of claim 9, wherein the locking mechanism comprises a pair of slots on an inner surface of the cavity, and the cover has a pair of tabs, which are configured to be received within the slots and upon rotation of the cover, the comestible pet treat is pushed upward into the opening.

12. The holder of claim 1, wherein the opening is in a shape of a dog bone.

13. The holder of claim 1, comprising:
means for attached the lower surface of the holder to floor, wall, and/or fixed object.

14. A comestible pet treat configured to be received within an opening of a pet treat holder in which only a portion of the comestible pet treat is accessible from an upper surface of the pet treat holder, the comestible pet treat comprising:
an upper portion sized to fit within the opening of the pet treat holder; and
a base portion attached to the upper portion, the base portion having a flange, which extends around an outer edge of the base portion and is configured to engage a lower surface of the pet treat holder adjacent to the opening.

15. The comestible pet treat according to claim 14, wherein the upper portion of the comestible pet treat is comprised of a different composition of a carbohydrate base, a protein powder or dry digest, and/or a flavorant than the base portion of the comestible pet treat.

16. The comestible pet treat according to claim 14, comprising:
a liquid center within the base portion of the comestible pet treat.

17. The comestible pet treat according to claim 14, wherein at least one of the upper portion and/or the base portion swells upon exposure to moisture and/or saliva to lock the upper portion and/or the base portion within the opening of the pet treat holder.

18. The comestible pet treat according to claim 14, wherein the comestible pet treat comprises:
a carbohydrate or sugar base;
a plant protein, an animal protein powder, or dry digest; and
a flavorant selected from the group consisting of meat, fish, and poultry.

19. The comestible pet treat according to claim 14, wherein the upper portion has a first flavorant and the base portion has a second flavorant, the first and second flavorants being different.

20. The comestible pet treat according to claim 14, wherein the upper portion is in a shape of a dog bone, and/or the upper portion is a first color and the base portion is a second color.
